(19) United States
(12) Patent Application Publication
(10) Pub. No.: US 2012/0043945 A1
(43) Pub. Date: Feb. 23, 2012

(54) APPARATUS FOR EQUALIZING VOLTAGE USING TIME SWITCH

(75) Inventors: Yong Wook KIM, Suwon (KR); Bae Kyun KIM, Seongnam (KR); Hee Bum LEE, Suwon (KR); Young Hak JEONG, Gunpo (KR); Seung Hyun RA, Seongnam (KR)

(73) Assignee: SAMSUNG ELECTRO-MECHANICS CO., LTD., Gyunggi-do (KR)

(21) Appl. No.: 13/005,260

(22) Filed: Jan. 12, 2011

(30) Foreign Application Priority Data
Aug. 17, 2010 (KR) 10-2010-0079478

(51) Int. Cl. H02J 7/00

(52) U.S. Cl. 320/167

(57) ABSTRACT

There is provided an apparatus for equalizing voltage using a time switch. The apparatus for equalizing voltage includes a plurality of energy storage unit cells connected in series; a single first balance capacitor connected with each energy storage unit cell in parallel through the first switch module for equally charging voltage between the plurality of energy storage unit cells; and a first switch module including a plurality of switches disposed between each energy storage unit cell and the first balance capacitor to sequentially open and close the connection between each energy storage unit cell and the first balance capacitor, whereby the voltage unbalance between the energy storage unit cells can be prevented at low cost.

### CROSS-REFERENCE TO RELATED APPLICATIONS

This application claims the priority of Korean Patent Application No. 10-2010-0079478 filed on Aug. 17, 2010, in the Korean Intellectual Property Office, the disclosure of which is incorporated herein by reference.

### BACKGROUND OF THE INVENTION

1. Field of the Invention

The present invention relates to an apparatus for equalizing voltage using a time switch, and more particularly, to an apparatus for equalizing voltage between energy storage unit cells by connecting a plurality of energy storage unit cells and a balance capacitor in parallel through an inexpensive time switch and sequentially opening and closing the connection between each energy storage unit cell and the balance capacitor.

2. Description of the Related Art

An ultra capacitor, which is one of various next-generation core energy storage devices, is an energy storage device supplementing the lower energy density and lower output characteristics of a secondary battery than those of the existing capacitors. Further, the ultra capacitor has a wide operating temperature from an extremely low temperature of 40 degrees below zero to 70° C. as well as excellent long-term reliability and as a result, can be applied to various fields such as a future car, an industrial power system, and the like.

Generally, the ultra capacitor configures a super capacitor module by connecting unit cells in series. The ultra capacitor is used by being connected with input terminals of inverters or converters. When the ultra capacitor is used in the manner of connecting unit cells in series, voltage charged in each unit cell is distributed by each capacitor value.

Meanwhile, when unit cells connected in series do not have uniform impedance, leakage current having different magnitudes flows in the unit cells, in particular, the voltage of unit cells in which high leakage current flows is lowered to a greater extent. As a result, voltage charged per unit cell becomes non-uniform, which can suddenly shorten the lifespan of unit cells in a super capacitor module and lead to accidents such as fires, explosions, or the like.

In order to solve these problems, research for equalizing voltage between unit cells has been conducted. However, most apparatuses for equalizing voltage use an expensive controller, thereby increasing manufacturing costs.

### SUMMARY OF THE INVENTION

An aspect of the present invention provides an apparatus for equalizing voltage capable of preventing a voltage unbalance between energy storage unit cells.

Further, another aspect of the present invention provides an apparatus for equalizing voltage capable of being implemented at low cost.

According to an aspect of the present invention, there is provided an apparatus for equalizing voltage, including: a plurality of energy storage unit cells connected in series; a single first balance capacitor connected with each energy storage unit cell in parallel for equally charging voltage between the plurality of energy storage unit cells; and a first switch module including a plurality of switches disposed between each energy storage unit cell and the first balance capacitor to sequentially open and close the connection between each energy storage unit cell and the first balance capacitor.

Each of the plurality of switches may include a pair of time switches repeating a turn-on/off operation according to a predetermined period.

The first switch module may repeat a process of sequentially opening and closing the connection with the first balance capacitor in sequence from a first energy storage unit cell to a final energy storage unit cell.

The first switch module may repeat a process of sequentially opening and closing the connection with the first balance capacitor from the first energy storage unit cell to the final energy storage unit cell and then, sequentially opening and closing the connection with the first balance capacitor again in sequence from the final energy storage unit cell to the first energy storage unit cell.

The apparatus for equalizing voltage may further include: a single second balance capacitor connected with each energy storage unit cell in parallel for equally charging voltage between the plurality of energy storage unit cells; and a second switch module including a plurality of switches that between each energy storage unit cell and the second balance capacitor to sequentially open and close the connection between each energy storage unit cell and the second balance capacitor.

The first switch module may repeat a process of sequentially opening and closing the connection with the first balance capacitor in sequence from the first energy storage unit cell to the final energy storage unit cell and the second switch module may repeat a process of sequentially opening and closing the connection with the second balance capacitor in sequence from the final energy storage unit cell to the first energy storage unit cell.

The first switch module may repeat a process of sequentially opening and closing the connection with the first balance capacitor from the first energy storage unit cell to the final energy storage unit cell and then, sequentially opening and closing the connection with the first balance capacitor again in sequence from the final energy storage unit cell to the first energy storage unit cell and the second switch module may repeat a process of sequentially opening and closing the connection with the second balance capacitor from the final energy storage unit cell to the first energy storage unit cell and then, sequentially opening and closing the connection with the second balance capacitor again in sequence from the first energy storage unit cell to the final energy storage unit cell.

Each energy storage unit cell may be one of an electric double layer capacitor, an aluminum electrolytic capacitor, and a tantalum electrolytic capacitor.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration diagram of an apparatus for equalizing voltage according to a first exemplary embodiment of the present invention;

FIGS. 2A and 2B are a timing diagram showing the connection opening and closing of a plurality of time switches used in the apparatus for equalizing voltage according to the first exemplary embodiment of FIG. 1;

FIG. 3 is a configuration diagram of an apparatus for equalizing voltage according to a second exemplary embodiment of the present invention; and

FIG. 4 is a timing diagram showing the connection opening and closing of the plurality of time switches used in the apparatus for equalizing voltage according to the second exemplary embodiment of FIGS. 2A and 2B.

### DETAILED DESCRIPTION OF THE PREFERRED EMBODIMENT

Hereinafter, exemplary embodiments of the present invention will be described in detail with reference to the accompanying drawings so that they can be easily practiced by those skilled in the art to which the present invention pertains. Here, the accompanying drawings may be shown in a somewhat exaggerated manner for the description thereof, and may be merely provided as a reference without limiting the scope of the present invention.

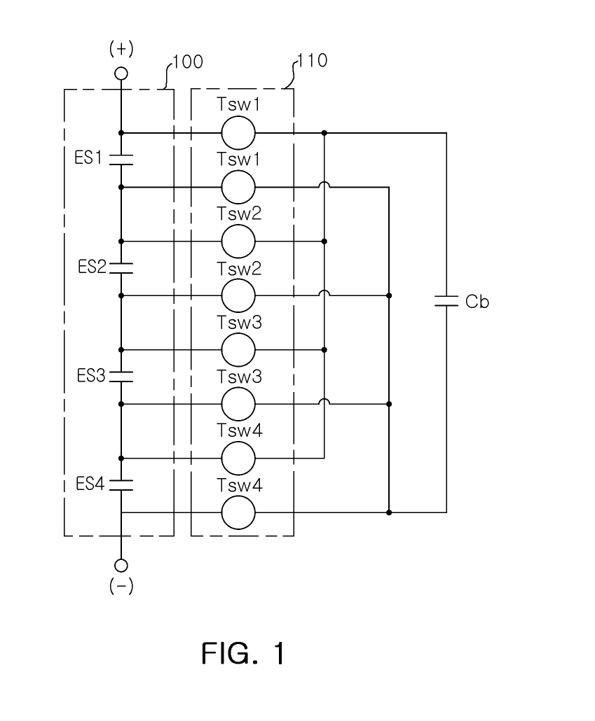

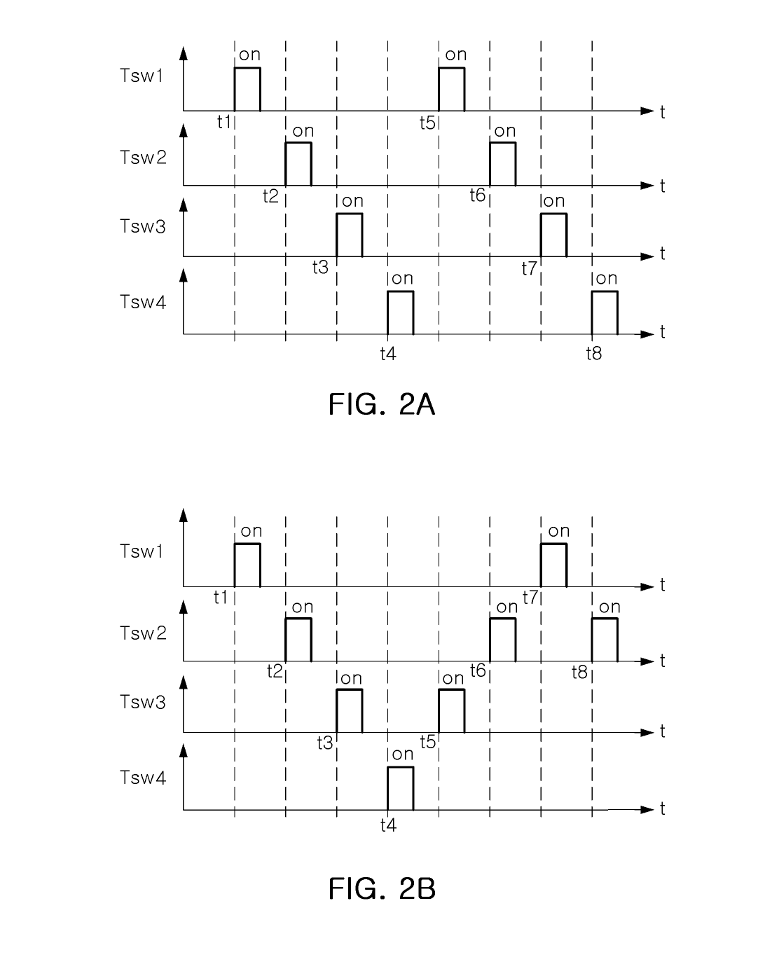

FIG. 1 is a configuration diagram of an apparatus for equalizing voltage according to a first exemplary embodiment of the present invention. An apparatus for equalizing voltage according to a first exemplary embodiment may include an energy storage module 100 including a plurality of energy storage unit cells ES1 to ES4 connected in series, a single first balance capacitor Cb, and a first switch module 110 having a plurality of switches T_{SW1} to T_{SW4}. Meanwhile, FIGS. 2A and 2B are a timing diagram showing the connection opening and closing of a plurality of time switches used in the apparatus for equalizing voltage according to the first exemplary embodiment of FIG. 1.

Hereinafter, the apparatus for equalizing voltage according to the present invention will be described in detail with reference to FIGS. 1, 2A and 2B.

The energy storage module 100 includes the plurality of energy storage unit cells ES1 to ES4 connected in series, wherein the energy storage unit cells ES1 to ES4 may include at least one of an electric double layer capacitor (DLC), an aluminum electrolytic capacitor, and a tantalum electrolytic capacitor. For convenience of explanation, FIG. 1 shows that the energy storage module 100 includes only four unit cells ES1 to ES4. Therefore, it is to be noted that the number of unit cells may be changed according to a demand of those skilled in the art.

The first balance capacitor Cb is a device for storing energy such as a capacitor, or the like. In particular, the connection between the first balance capacitor Cb and each energy storage unit cell ES1 to ES4 is sequentially opened and closed according to the operation of the first switch module 110 operated depending on the timing shown in FIGS. 2A and 2B, thereby making it possible to equalize voltage between the energy storage unit cells ES1 to ES4. According to an exemplary embodiment of the present invention, the first balance capacitor Cb can achieve voltage equalization by using only one capacitor, thereby making it possible to lower the manufacturing cost of the apparatus for equalizing voltage.

The first switch module 110 includes a plurality of switches, wherein each of the plurality of switches is formed in a pair. Each pair of switches is operated to be turned-on/off at the same timing. In detail, a switch T_{SW1} is disposed between the first energy storage unit cell ES1 and the first balance capacitor Cb, a switch T_{SW2} is disposed between the second energy storage unit cell ES2 and the first balance capacitor Cb, a switch T_{SW3} is disposed between the third energy storage unit cell ES3 and the first balance capacitor Cb, and a switch T_{SW4} is disposed between the fourth energy storage unit cell ES4 and the first balance capacitor Cb. Each switch T_{SW1} to T_{SW4} may include a time switch that repeatedly performs a turn-on/off operation at a predetermined period.

The sequence of the connection opening and closing of the above-mentioned first switch module 110 will be described in detail with reference to FIGS. 2A and 2B.

Referring to FIG. 2A, the switch T_{SW1} is turned-on at timing t1, such that the first energy storage unit cell ES1 is connected to the first balance capacitor Cb. Therefore, the voltage of the first energy storage unit cell ES1 is equal to that of the first balance capacitor Cb. Meanwhile, the switch T_{SW1} is turned-off as predetermined timing passes.

Thereafter, as the switch T_{SW2} is turned-on at timing t2, the second energy storage unit cell ES2 is connected to the first balance capacitor Cb. Therefore, the voltage of the second energy storage unit cell ES2 is equal to that of the first balance capacitor Cb. Meanwhile, the switch T_{SW2} is turned-off as predetermined timing passes.

Thereafter, as the switch T_{SW3} is turned-on at timing t3, the third energy storage unit cell ES3 is connected to the first balance capacitor Cb. Therefore, the voltage of the third energy storage unit cell ES3 is equal to that of the first balance capacitor Cb. Meanwhile, the switch T_{SW3} is turned-off as predetermined timing passes.

Thereafter, as the switch T_{SW4} is turned-on at timing t4, the fourth energy storage unit cell ES4 is connected to the first balance capacitor Cb. Therefore, the voltage of the fourth energy storage unit cell ES4 is equal to that of the first balance capacitor Cb. Meanwhile, the switch T_{SW4} is turned-off as predetermined timing passes.

That is, as shown in FIG. 2A, a process of opening and closing the connection in sequence from the first energy storage unit cell ES1 to the fourth energy storage unit cell ES4 and then, opening and closing the connection in sequence from the first energy storage unit cell ES1 to the fourth energy storage unit cell ES4 is repeated.

The foregoing process may be performed repeatedly. The connection between a single first balance capacitor Cb and each energy storage cell ES1 to ES4 is sequentially opened and closed, such that the energy storage unit cells ES1 to ES4 may have the same voltage. As described above, the exemplary embodiment of the present invention uses the inexpensive time switches T_{SW1} to T_{SW4} rather than using an expensive controller such as a microprocessor or the like for voltage equalization. Therefore, the apparatus for equalizing voltage may be implemented at low cost.

Meanwhile, the present invention may be implemented in sequence different from FIG. 2A and the detailed description thereof will be described with reference to FIG. 2B.

Referring to FIG. 2B, the operation is the same as that of FIG. 2A until timing t4. However, at timing t5, the connection between the third energy storage unit cell ES3 and the first balance capacitor Cb is opened and closed rather than the connection between the first energy storage unit cell ES1 and the first balance capacitor Cb is opened and closed. Thereafter, at timing t6, the connection between the second energy storage unit cell ES2 and the first balance capacitor Cb is opened and closed and at timing t6, the connection between the first energy storage unit cell ES1 and the first balance capacitor Cb is again opened and closed. The foregoing process is performed repeatedly.

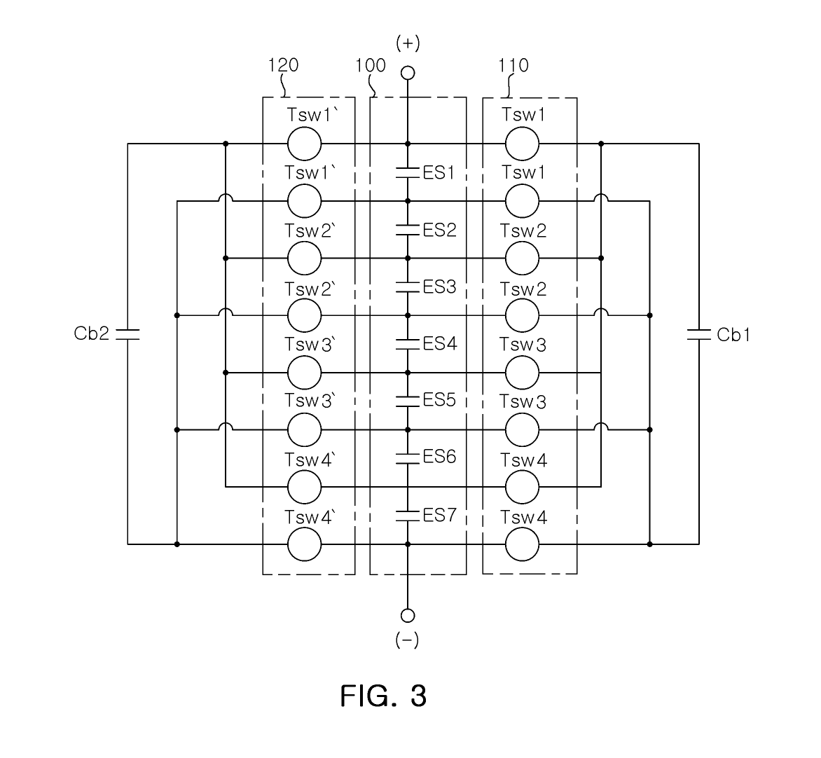

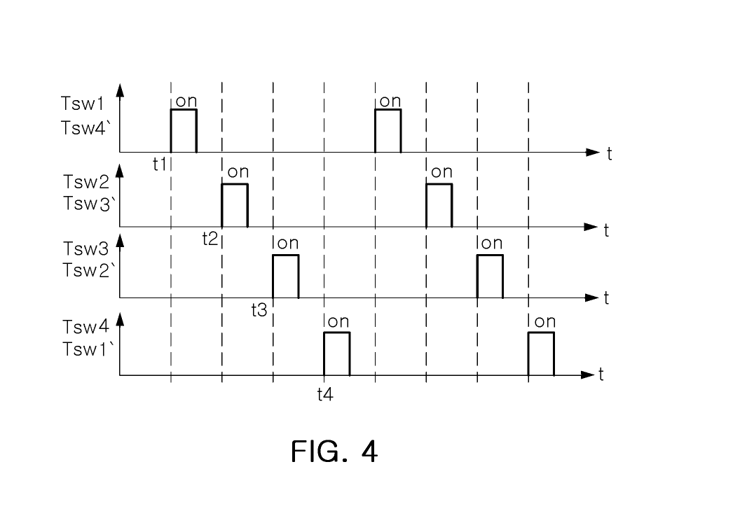

Meanwhile, FIG. 3 is a configuration diagram of an apparatus for equalizing voltage according to a second exemplary embodiment of the present invention. Unlike FIG. 1, the apparatus for equalizing voltage is configured to further include a second switch module 120 and a second balance capacitor Cb2. FIG. 4 is a timing diagram showing the connection opening and closing of the plurality of time switches used in the apparatus for equalizing voltage according to the second exemplary embodiment of FIGS. 2A and 2B.

Referring to FIG. 3, the second switch module 120 includes a plurality of switches and shown in FIG. 1, wherein each of the plurality of switches is configured in a pair. Each pair of switches is operated to be turned-on/off at the same timing. In detail, a switch T_{SW1′} is disposed between the first energy storage unit cell ES1 and the first balance capacitor Cb1, a switch T_{SW2′} is disposed between the second energy storage unit cell ES2 and the first balance capacitor Cb1, a switch T_{SW3′} is disposed between the third energy storage unit cell ES3 and the first balance capacitor Cb1, and a switch T_{SW4′} is disposed between the fourth energy storage unit cell ES4 and the first balance capacitor Cb1. Each switch T_{SW1′} to T_{SW4′} may include a time switch that repeatedly perform a turn-on/off operation at a predetermined period.

Similarly, the second balance capacitor Cb2 is a device for storing energy such as a capacitor, or the like. In particular, the connection between the first balance capacitor Cb1 and the second balance capacitor Cb2 and each energy storage unit cell ES1 to ES4 is sequentially opened and closed according to the operation of the first switch module 110 and the second switch module 120 operated depending on the timing shown in FIG. 4, thereby making it possible to equalize voltage between the energy storage unit cells ES1 to ES4. As shown in FIG. 3, when the apparatus for equalizing voltage uses two balance capacitors Cb1 and Cb2, it can perform the voltage equalization within time earlier than when it uses the single balance capacitor Cb1 Further, when the first balance capacitor Cb1 is operated abnormally due to the unexpected failure, the apparatus for equalizing voltage can perform the voltage equalization through the second balance capacitor Cb2 and secure the reliability accordingly. Although the present invention is configured to include only two balance capacitors Cb1 and Cb2, it may be configured to include at least three balance capacitors if necessary.

The sequence of the connection opening and closing of the above-mentioned first switch module 110 and the second switch module 120 will be described in detail with reference to FIG. 4.

Referring to FIG. 4, as the switch T_{SW1} is first turned-on at timing t1, the first energy storage unit cell ES1 is connected to the first balance capacitor Cb1. Further, as the switch T_{SW4′} is turned-on at timing t1, the fourth energy storage unit cell ES4 is connected to the second balance capacitor Cb2. Therefore, the voltage of the first energy storage unit cell ES1 is equal to that of the first balance capacitor Cb1 and the voltage of the fourth energy storage unit cell ES4 is equal to that of the second balance capacitor Cb2. Meanwhile, the switches T_{SW1} and T_{SW4′} are turned-off as predetermined timing passes.

Thereafter, as the switch T_{SW2} is turned-on at timing t2, the second energy storage unit cell ES2 is connected to the first balance capacitor Cb1. Further, as the switch T_{SW3′} is turned-on at timing t2, the third energy storage unit cell ES3 is connected to the second balance capacitor Cb2. Therefore, the voltage of the second energy storage unit cell ES2 is equal to that of the first balance capacitor Cb1 and the voltage of the third energy storage unit cell ES3 is equal to that of the second balance capacitor Cb2. Meanwhile, the switches T_{SW2} and T_{SW3′} are turned-off as predetermined timing passes.

Thereafter, as the switch T_{SW3} is turned-on at timing t3, the third energy storage unit cell ES3 is connected to the first balance capacitor Cb1. Further, as the switch T_{SW2′} is turned-on at timing t3, the second energy storage unit cell ES2 is connected to the second balance capacitor Cb2. Therefore, the voltage of the third energy storage unit cell ES3 is equal to that of the first balance capacitor Cb1 and the voltage of the second energy storage unit cell ES2 is equal to that of the second balance capacitor Cb1. Meanwhile, the switches T_{SW3} and T_{SW2′} are turned-off as predetermined timing passes.

Thereafter, as the switch T_{SW4} is turned-on at timing t4, the fourth energy storage unit cell ES4 is connected to the first balance capacitor Cb1. Further, as the switch T_{SW1′} is turned-on at timing t4, the first energy storage unit cell ES1 is connected to the second balance capacitor Cb2. Therefore, the voltage of the fourth energy storage unit cell ES4 is equal to that of the first balance capacitor Cb1 and the voltage of the first energy storage unit cell ES1 is equal to that of the second balance capacitor Cb2. Meanwhile, the switches T_{SW1} and T_{SW4′} are turned-off as predetermined timing passes.

That is, as shown in FIG. 4, the process of opening and closing the connection of the first balance capacitor Cb1 in sequence from the switch T_{SW1} to the switch T_{SW4} and opening and closing the connection of the second balance capacitor Cb2 in sequence from the switch T_{SW4′} to T_{SW1′} are repeated according to the switching operation of the first switch module 110 and the second switch module 120.

The above-mentioned process may be performed repeatedly. The connection between two balance capacitors Cb1 and Cb2 and each energy storage unit cell ES1 to ES4 is sequentially opened and closed, such that the energy storage unit cells ES1 to ES4 may have the same voltage. As described above, the exemplary embodiment of the present invention uses the inexpensive time switches T_{SW1} to T_{SW4} and T_{SW1′} to T_{SW4′} rather than using the expensive controller such as a microprocessor, or the like, for the voltage equalization. Therefore, the apparatus for equalizing voltage may be implemented at low cost.

As set forth above, the present invention connects the plurality of energy storage unit cells to a single balance capacitor in parallel through the time switch and sequentially opens and closes the connection between each energy storage unit cell and the balance capacitor, thereby making it possible to prevent the voltage unbalance between the energy storage unit cell.

Further, according to the present invention, the apparatus for equalizing voltage performs the voltage equalization using the inexpensive time switch rather than using the expensive devices such as the microprocessor, such that it can be implemented at low cost.

While the present invention has been shown and described in connection with the exemplary embodiments, it will be apparent to those skilled in the art that modifications and variations can be made without departing from the spirit and scope of the invention as defined by the appended claims.

What is claimed is:

1. An apparatus for equalizing voltage, comprising:
a plurality of energy storage unit cells connected in series;
a single first balance capacitor connected with each energy storage unit cell in parallel for equally charging voltage between the plurality of energy storage unit cells; and
a first switch module including a plurality of switches disposed between each energy storage unit cell and the first balance capacitor to sequentially open and close the connection between each energy storage unit cell and the first balance capacitor.

2. The apparatus for equalizing voltage of claim 1, wherein each of the plurality of switches includes a pair of time switches repeating a turn-on/off operation according to a predetermined period.

3. The apparatus for equalizing voltage of claim 2, wherein the first switch module repeats a process of sequentially opening and closing the connection with the first balance capacitor in sequence from a first energy storage unit cell to a final energy storage unit cell.

4. The apparatus for equalizing voltage of claim 2, wherein the first switch module repeats a process of sequentially opening and closing the connection with the first balance capacitor from the first energy storage unit cell to the final energy storage unit cell and then, sequentially opening and closing the connection with the first balance capacitor again in sequence from the final energy storage unit cell to the first energy storage unit cell.

5. The apparatus for equalizing voltage of claim 2, further comprising:
a single second balance capacitor connected with each energy storage unit cell in parallel for equally charging voltage between the plurality of energy storage unit cells; and
a second switch module including a plurality of switches disposed between each energy storage unit cell and the second balance capacitor to sequentially open and close the connection between each energy storage unit cell and the second balance capacitor

6. The apparatus for equalizing voltage of claim 5, wherein the first switch module repeats a process of sequentially opening and closing the connection with the first balance capacitor in sequence from the first energy storage unit cell to the final energy storage unit cell, and
the second switch module repeats a process of sequentially opening and closing the connection with the second balance capacitor in sequence from the final energy storage unit cell to the first energy storage unit cell.

7. The apparatus for equalizing voltage of claim 5, wherein the first switch module repeats a process of sequentially opening and closing the connection with the first balance capacitor from the first energy storage unit cell to the final energy storage unit cell and then, sequentially opening and closing the connection with the first balance capacitor again in sequence from the final energy storage unit cell to the first energy storage unit cell, and
the second switch module repeats a process of sequentially opening and closing the connection with the second balance capacitor from the final energy storage unit cell to the first energy storage unit cell and then, sequentially opening and closing the connection with the second balance capacitor again in sequence from the first energy storage unit cell to the final energy storage unit cell.

8. The apparatus for equalizing voltage of claim 1, wherein each energy storage unit cell is one of an electric double layer capacitor, an aluminum electrolytic capacitor, and a tantalum electrolytic capacitor.
